(19) United States
(12) Patent Application Publication
(10) Pub. No.: US 2026/0353381 A1
(43) Pub. Date: Nov. 5, 2026

(54) Dynamic Downlink Resource Assignment During Connected DRX Operation For XR

(71) Applicant: Apple Inc., Cupertino, CA (US)

(72) Inventors: Ping-Heng KUO, London (GB); Fangli XU, Beijing (CN); Haijing HU, Los Gatos, CA (US); Naveen Kumar R. PALLE VENKATA, San Diego, CA (US); Peng CHENG, Beijing (CN); Ralf ROSSBACH, Munich (DE); Zhibin WU, Los Altos, CA (US)

(21) Appl. No.: 19/099,900

(22) PCT Filed: Aug. 1, 2023
(86) PCT No.: PCT/US2023/029187

§ 371 Date: Jan. 30, 2025

Related U.S. Application Data
(60) Provisional application No. 63/370,392, filed on Aug. 4, 2022.

(51) Int. Cl. H04W 72/11; H04W 72/232; H04W 76/28

(52) U.S. Cl. CPC H04W 72/11; H04W 72/232; H04W 76/28

(57) ABSTRACT

A user equipment (UE) configured to decode, from signaling received from a base station, configuration information for a semi-persistent scheduling (SPS) configuration comprising one or more SPS occasions, determine whether a condition relating to the one or more SPS occasions of the SPS configuration has occurred and utilize an active mode of monitoring physical downlink control channel (PDCCH) to receive a dynamic downlink resource assignment in response to determining that the condition relating to the one or more SPS occasions has occurred.

### BACKGROUND

A fifth generation (5G) new radio (NR) network may support extended reality (XR) services. Due to the periodical nature of XR traffic, a semi-persistent scheduling (SPS) approach may be used by the network for resource allocation. Certain characteristics of XR traffic such as, but not limited to, late packet arrival due to jitter and time-varying packet size may create a scenario where the network needs additional downlink resources to provide the data to the user equipment (UE). To account for these types of characteristics of XR traffic the network may utilize supplementary downlink dynamic resource assignment via physical downlink control channel (PDCCH). However, in some scenarios the UE may not be in an active mode of monitoring PDCCH when the network intends to send the supplementary downlink dynamic resource assignment to the UE due to a connected discontinuous reception (cDRX) configuration. The network may wait until a next onDuration of the cDRX cycle to provide the supplementary dynamic resource assignment. However, this approach may cause latency which is undesirable for delay-sensitive traffic, e.g., XR traffic.

### SUMMARY

Some exemplary embodiments are related to an apparatus of a user equipment (UE), the apparatus having processing circuitry configured to decode, from signaling received from a base station, configuration information for a semi-persistent scheduling (SPS) configuration comprising one or more SPS occasions, determine whether a condition relating to the one or more SPS occasions of the SPS configuration has occurred and utilize an active mode of monitoring physical downlink control channel (PDCCH) to receive a dynamic downlink resource assignment in response to determining that the condition relating to the one or more SPS occasions has occurred.

Other exemplary embodiments are related to an apparatus of a base station, the apparatus having processing circuitry configured to configure transceiver circuitry to transmit configuration information for a semi-persistent scheduling (SPS) configuration to a user equipment (UE) and configure transceiver circuitry to transmit a dynamic downlink resource assignment to the UE after a condition relating to one or more SPS occasions of the SPS configuration has occurred, wherein the dynamic downlink resource assignment is transmitted on a physical downlink control channel (PDCCH).

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary scenario for late packet arrival due to jitter according to various exemplary embodiments.

FIG. 5 shows an exemplary scenario for time-varying size according to various exemplary embodiments.

FIG. 6 shows a method for receiving a supplementary downlink resource assignment during connected discontinuous reception (cDRX) operation according to various exemplary embodiments

FIG. 7 shows an exemplary medium access control (MAC) control element (CE) according to various exemplary embodiments.

FIG. 8 shows an example abstract syntax notation one (ASN.1) for an exemplary radio resource control (RRC) information element (IE) according to various exemplary embodiments.

FIG. 9 shows an exemplary MAC CE according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) receiving a dynamic downlink resource assignment during connected discontinuous reception (cDRX) operation.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a 5G NR network that supports extended Reality (XR). Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). While the exemplary embodiments are described with reference to XR, it should be understood that the exemplary embodiments may be applied to any supplementary dynamic downlink resource assignment mechanism that may be utilized during a UE power saving mode. That is, the exemplary embodiments are not limited to scenarios where the UE is engaged in XR operations.

XR services may utilize multiple data flows in the uplink and/or downlink. For example, in the downlink, there may be a video stream, an audio stream and/or a data stream. In the uplink, there may be a control stream and/or a pose stream. From a physical channel perspective, there may be different control channels and shared channels for each stream or multiple streams may share a control channel and/or shared channel. In some configurations, each stream may have different quality of service (QOS) requirements (e.g., block error rate (BLER), latency requirements, etc.).

For XR, data payload is typically periodical. For example, a video frame rate may be 60, 90 or 120 frames per second (fps). This results in packet arrival rates with non-integer periodicities in terms of milli-seconds (e.g., 16.67 ms for 60 fps, 11.11 ms for 90 ms, and 8.33 ms for 120 fps). The network may obtain assistance information related to the characteristics of the XR traffic and utilize the assistance information to perform resource allocation for the XR services. Due to the periodical nature of XR traffic, a semi-persistent scheduling (SPS) approach may be used by the network for resource allocation.

XR traffic may have characteristics such as a quasi-periodic packet arrival rate due to random jitter and a packet size that may vary over time. Furthermore, the configured SPS periodicity may not be aligned with the expected XR packet arrival rates. In particular, in current specifications only SPS periodicities with integer millisecond values can be supported (e.g., 10 ms, 20 ms, 32 ms, 40 ms, etc.), which may be insufficient to accommodate packet arrival rates with non-integer periodicities in terms of milli-seconds (e.g., 16.67 ms, 11.11 ms, and 8.33 ms) as time mismatch between packet arrival and SPS occasion may occur. To account for these types of characteristics the network may support supplementary dynamic downlink resource assignment. For example, a packet may arrive late at a gNB due to random jitter and as a result, the gNB cannot transmit the data during an SPS occasion. When the packet finally arrives at the gNB, the gNB may issue a dynamic downlink resource assignment via physical downlink control channel (PDCCH) to the UE to schedule a subsequent downlink data transmission. In another example, an SPS occasion may not be large enough for certain packet sizes. To accommodate the remaining data of the packet that could not be transmitted on the SPS occasion, the gNB issues a dynamic downlink resource assignment via PDCCH to the UE to schedule a subsequent downlink data transmission.

The exemplary embodiments are also described with regard to cDRX operation. Those skilled in the art will understand that cDRX generally refers to a UE power saving mechanism. A cDRX cycle may be configured with a time duration during which the UE is scheduled to utilize an active mode of monitoring PDCCH. Outside of the scheduled time duration, the UE may have the opportunity to utilize a sleep mode and conserve power by not actively monitoring PDCCH.

During cDRX operation, a scenario may occur where the UE is not utilizing an active mode of monitoring PDCCH when the gNB intends to send PDCCH for the dynamic downlink resource assignment. For example, the downlink traffic may arrive at the gNB within a time duration where the UE is in a sleep mode and does not monitor PDCCH. Such a time mismatch may occur if the downlink packet experiences a jitter, or if the packet arrival rate is not aligned with the configured DRX cycle. In particular, the packet arrival rates may be non-integer periodicities in terms of milliseconds, while in some scenarios only integer DRX cycles (in units of milliseconds) can be supported, and so it may result in timing mismatch between packet arrival and UE active mode. In such cases, the gNB may wait until the UE enters an active mode of monitoring PDCCH in accordance with the cDRX cycle to send PDCCH for the dynamic downlink resource assignment. However, this approach may cause latency which is undesirable for delay-sensitive traffic, e.g., XR traffic.

The exemplary embodiments introduce techniques that are configured to ensure that the UE is in an active mode of monitoring PDCCH to receive a dynamic downlink resource assignment on PDCCH when SPS operation is impacted by certain characteristics of XR traffic. According to some aspects, the exemplary embodiments introduce techniques for utilizing a medium access control (MAC) control element (CE) to trigger an active mode of monitoring PDCCH during cDRX operation for the reception of the dynamic downlink resource assignment. In another aspect, the exemplary embodiments introduce techniques for using layer 1 (L1) and/or layer 2 (L2) signaling to trigger an active mode of monitoring PDCCH during cDRX operation for the reception of the dynamic downlink resource assignment. According to other aspects, the exemplary embodiments introduce timer-based techniques for controlling the active mode of monitoring PDCCH during cDRX operation for the reception of the dynamic downlink resource assignment. Each of these exemplary techniques will be described in detail below. The exemplary techniques introduced herein may be used independently from one another, in conjunction with other currently implemented mechanisms for dynamic downlink resource assignment reception during cDRX operation, in conjunction with future implementations of mechanisms for dynamic downlink resource assignment reception during cDRX operation or independently from other mechanisms related to dynamic downlink resource assignment reception during cDRX operation.

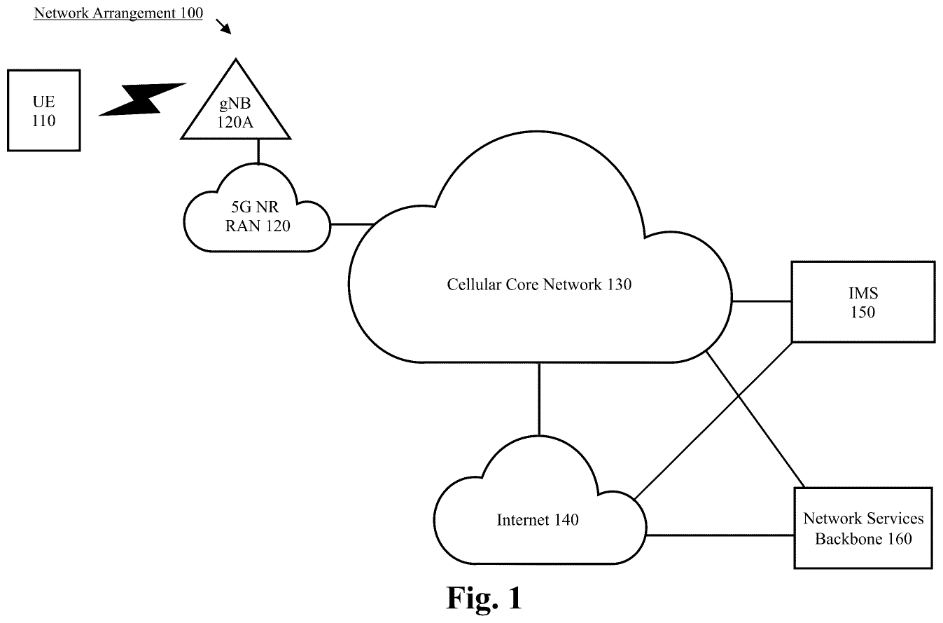

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

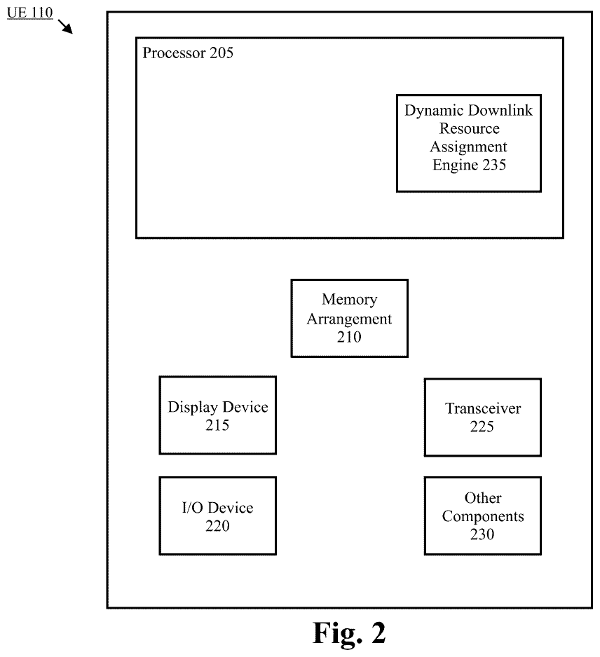

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a dynamic downlink resource assignment engine 235. The dynamic downlink resource assignment engine 235 may perform a variety of operations for receiving dynamic downlink resource assignment via PDCCH during cDRX operation and other related techniques described herein. The operations may include, but are not limited to, receiving configuration information, identifying conditions related to an SPS occasion and determining when to utilize an active mode of monitoring PDCCH.

The above referenced engine being an application (e.g., a program) executed by the processor 205 is merely provided for illustrative purposes. The functionality associated with the dynamic downlink resource assignment engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 includes circuitry configured to transmit and/or receive signals (e.g., control signals, data signals).

Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

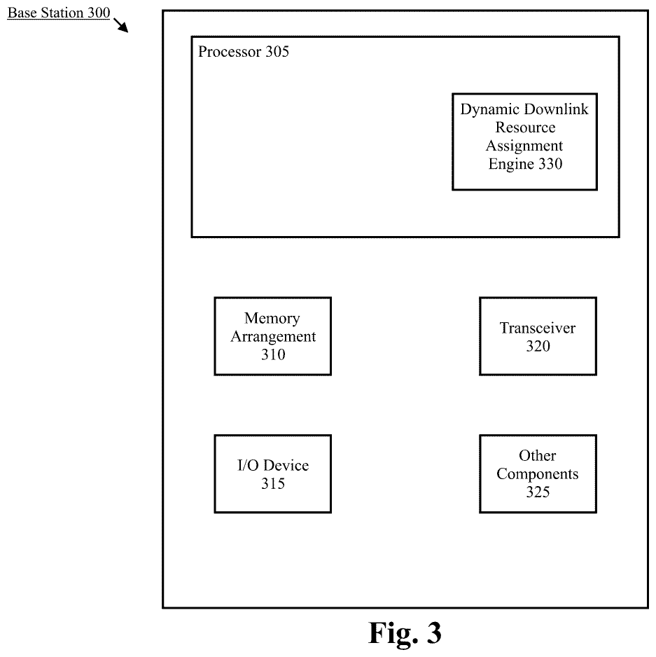

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a dynamic downlink resource assignment engine 330. The dynamic downlink resource assignment engine 330 may perform a variety of operations for transmitting a dynamic downlink resource assignment via PDCCH during cDRX operation at the UE and other related techniques described herein. The operations may include, but are not limited to, transmitting configuration information, triggering the UE 110 to enter or stay in an active mode of monitoring PDCCH during a cDRX cycle and transmitting a supplementary dynamic downlink resource assignment to the UE 110.

The above noted engine being an application (e.g., a program) executed by the processor 305 is only exemplary. The functionality associated with the dynamic downlink resource assignment engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

The exemplary embodiments are described with regard to cDRX operation. Those skilled in the art will understand that cDRX is a power saving mechanism that may be implemented by the UE 110 when in RRC connected mode. A cDRX cycle may comprise a time duration during which the UE is scheduled to use an active mode of monitoring PDCCH In the examples described below, a scheduled time duration during which the UE 110 may utilize an active mode of monitoring PDCCH may be referred to as an onDuration.

The UE 110 may also be configured with an SPS occasion. Those skilled in the art will understand that an SPS occasion may include preconfigured downlink radio resources with time and frequency locations that are known to the UE 110. This enables the UE 110 to receive PDSCH without dynamic signaling from the network for downlink resource assignment.

Outside of an onDuration, the UE 110 may have an opportunity to utilize a sleep mode and conserve power by not monitoring PDCCH. Throughout this description, reference to a power saving mode or a sleep mode does not necessarily mean putting the processor 205, the transmitter, and the receiver of the UE 110 to sleep, in hibernation, or in deactivation. For example, the processor 205 (e.g., baseband and/or application) may continue to execute other applications or processes. The sleep mode relates to conserving power by discontinuing a continuous processing functionality relating to operations that enable the UE 110 to monitor PDCCH.

The cDRX cycle may have a predetermined duration (N), e.g., 100 milliseconds (ms), 50 ms, 40 ms, 20 ms, etc. To provide an example, at a time 0, there may be a onDuration during which the active mode of monitoring PDCCH. Upon the conclusion of the onDuration, the UE 110 has an opportunity to utilize the sleep mode and conserve power by not monitoring PDCCH. At a time N, there may be another onDuration. Subsequently, the sleep mode may be used until a time 2N. This process may continue until the cDRX cycle is no longer configured at the UE 110. Reference to the cDRX cycle being configured in units of milliseconds is merely for illustrative purposes, the exemplary embodiments may utilize a cDRX cycle that is based on subframes or any other suitable unit of time.

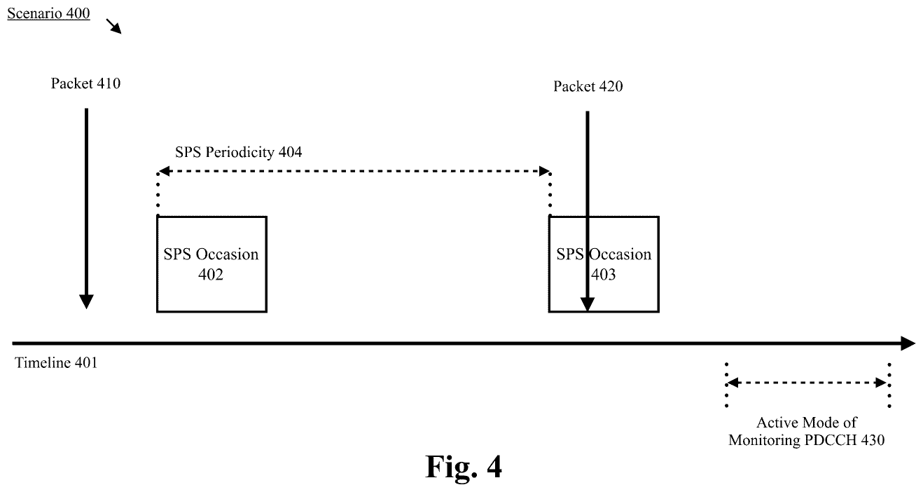

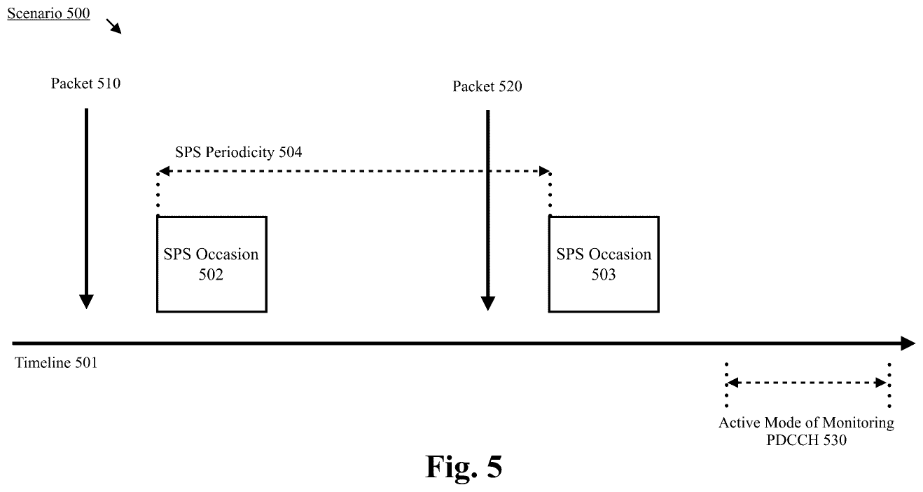

As mentioned above, the exemplary embodiments introduce techniques configured to ensure that the UE 110 is in an active mode of monitoring PDCCH to receive a dynamic downlink resource assignment on PDDCH when SPS operation is impacted by certain aspects of XR traffic during cDRX operation. Prior to discussing the exemplary techniques introduced herein, two example scenarios are described in FIGS. 4-5 in which the UE 110 may receive PDCCH for the dynamic downlink assignment outside of an SPS occasion due to late packet arrival caused by, for example, jitter and time-varying packet size. While the exemplary embodiments are described with reference to these aspects of XR traffic, it should be understood that the exemplary techniques introduced herein may be applied to any supplementary dynamic downlink resource assignment mechanism that may be utilized during a UE 110 power saving mode. That is, the exemplary embodiments are not limited to these characteristics of XR traffic or even scenarios where the UE 110 is engaged in XR operations.

FIG. 4 shows an exemplary scenario 400 for late packet arrival due to jitter according to various exemplary embodiments. The exemplary scenario 400 is described with regard to the exemplary network arrangement 100 of FIG. 1, the UE 110 of FIG. 2 and the base station 300 of FIG. 3.

A timeline 401 comprises a first SPS occasion 402 and a second SPS occasion 403 separated in time by a configured SPS periodicity 404.

In 410, a first packet is received at the base station 300 before the SPS occasion 402. Since the packet was received by the base station 300 prior to the SPS occasion 402, the base station 300 can transmit the corresponding data on the PDSCH during the SPS occasion 402.

In 420, a second packet arrives at the base station 300 during the SPS occasion 403. This late packet arrival may be caused due to jitter. The jitter is characterized by a random variable following a probability distribution and thus, the expected periodic traffic may be considered “quasi-periodic.” Due to the late packet arrival, the base station 300 may be unable to transmit the corresponding data on the PDSCH during the SPS occasion 403.

The network may utilize a dynamic downlink resource assignment to schedule a PDSCH occasion during which the base station 300 may provide the data of the second packet to the UE 110. However, during cDRX operation, the UE 110 may be in a sleep mode when the base station 300 intends to send the dynamic downlink resource assignment to the UE 110 via PDCCH. The exemplary embodiments introduce techniques to ensure that the UE 110 is in an active mode of monitoring PDCCH for the dynamic downlink resource assignment when SPS operation is impacted by jitter at the base station 300. An example of this active mode of monitoring PDCCH for the dynamic downlink resource assignment is shown by the time duration 430.

FIG. 5 shows an exemplary scenario 500 for time-varying size according to various exemplary embodiments. The exemplary scenario 500 is described with regard to the exemplary network arrangement 100 of FIG. 1, the UE 110 of FIG. 2 and the base station 300 of FIG. 3.

A timeline 501 comprises a first SPS occasion 502 and a second SPS occasion 503 separated in time by a configured SPS periodicity 504.

In 510, a first packet is received at the base station 300 before the SPS occasion 402. In addition, the SPS occasion 402 is sufficient to accommodate the data of the first packet. Since the first packet was received by the base station 300 prior to the SPS occasion 502, the base station 300 can transmit the corresponding data on PDSCH during the SPS occasion 502.

In 520, a second packet arrives at the base station 300 prior to the SPS occasion 403. However, the size of the second packet is larger than the first packet and the SPS occasion 503 alone is not sufficient to accommodate the data of the first packet. In this example, since the second packet arrived at the base station 300 prior to the SPS occasion 503, the base station 300 may transmit some of the data corresponding to the second packet during the SPS occasion 503.

The network may utilize a dynamic downlink resource assignment to schedule a PDSCH occasion during which the base station 300 may provide at least the remaining portion of the data from second packet. However, during cDRX operation, the UE 110 may be in a sleep mode when the base station 300 intends to send the dynamic downlink resource assignment to the UE 110 via PDCCH. The exemplary embodiments introduce techniques to ensure that the UE 110 is in an active mode of monitoring PDCCH to receive the PDCCH for the dynamic downlink resource assignment when SPS operation is impacted by time-varying packet size at the base station 300. An example of this active mode of monitoring PDCCH to receive PDCCH for the dynamic downlink resource assignment is shown by the time duration 530.

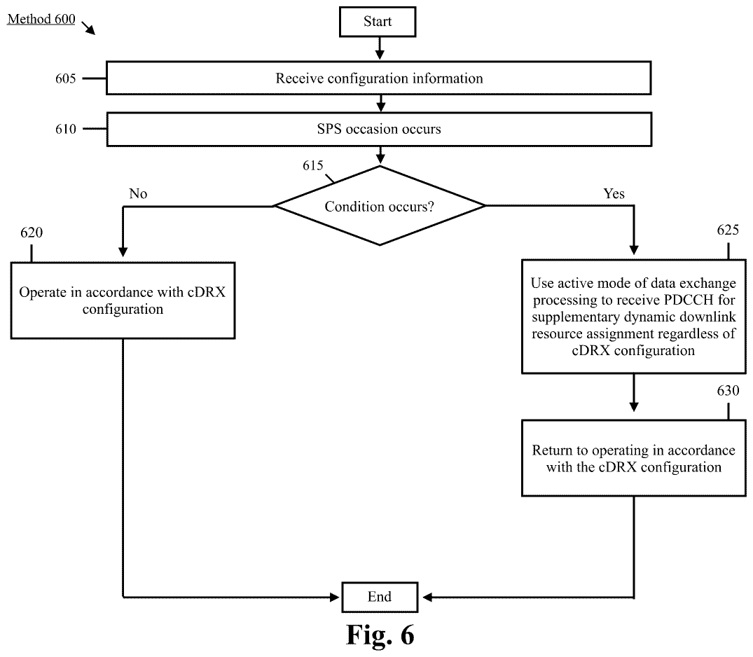

FIG. 6 shows a method 600 for receiving a supplementary downlink resource assignment during cDRX operation according to various exemplary embodiments. The method 600 is described from the perspective of the UE 110 and provides a general overview of a scenario during which various exemplary techniques described herein may be utilized.

In 605, the UE 110 receives configuration information from the network. The configuration information may be provided in any appropriate manner, e.g., system information, RRC messages, control information, MAC CEs, DCI, any combination thereof, etc. For example, the UE 110 may receive one or more RRC messages comprising parameters for cDRX operation. The UE 110 may also receive SPS configuration information in one or more RRC messages. The SPS configuration information may include parameters that enable the UE 110 to determine when an SPS occasion is scheduled to occur such as, but not limited to, an SPS periodicity. Those skilled in the art will understand that the UE 110 may have more than one SPS configuration and each SPS configuration may be activated/deactivated by the network.

In addition, the UE 110 may also receive configuration information related to the exemplary techniques introduced herein. Generally, this configuration information may relate to UE 110 behavior for scenarios where SPS operation is impacted by certain aspects of XR traffic during cDRX operation. To provide some examples, this configuration information may include parameters for operating a timer that is configured to control when the UE 110 is to utilize an active mode of monitoring PDCCH and/or predetermined conditions that are to trigger the UE 110 to utilize an active mode of monitoring PDCCH reception. However, these examples are merely provided for illustrative purposes and are not intended to limit the exemplary embodiments in any way. Additional examples of the type of configuration information that may be provided to the UE 110 for scenarios where SPS operation is impacted by certain aspects of XR traffic during cDRX operation are provided in detail below after the description of the method 600.

In 610, an SPS occasion occurs. As will be described in more detail below, when processing the SPS occasion the UE 110 may identify a condition indicating that a supplementary dynamic downlink resource assignment is likely to be transmitted to the UE 110. In response, the UE 110 may monitor PDCCH for a supplementary dynamic downlink resource assignment during a time duration that is outside of an onDuration of the cDRX cycle.

In 615, the UE 110 determines whether a condition relating to one or more SPS occasions has occurred. The condition may indicate that a supplementary dynamic downlink resource assignment is likely to be transmitted to the UE 110 has occurred. For example, SPS operation may be impacted by certain characteristics of XR traffic such as late packet arrival caused by jitter and time-varying packet size. The network may provide a dynamic downlink resource assignment via PDCCH for additional PDSCH resources to supplement SPS PDSCH when SPS operation is impacted by XR traffic.

One exemplary condition may include whether the SPS occasion is perceived to be empty by the UE 110. For example, a transport block may not actually be transmitted during the SPS occasion when late packet arrival due to jitter causes the base station 300 to miss the SPS occasion. The UE 110 may make this determination based on the presence or absence of demodulated reference signals (DMRS) during the SPS occasion. The presence of DMRS may indicate that a transport block for the UE 110 has actually been transmitted to the UE 110 during the SPS occasion. The absence of DMRS may indicate that the transport block has not been transmitted to the UE 110 during the SPS occasion.

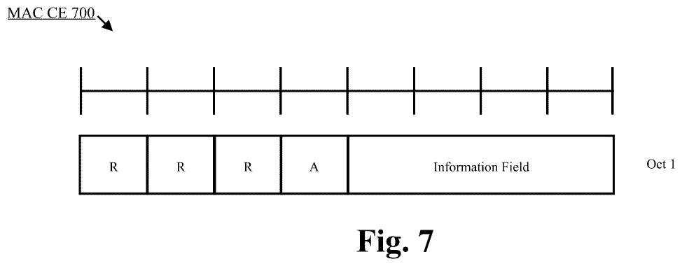

According to some aspects, the exemplary embodiments introduce a MAC CE that may be provided by the network prior to or during an SPS occasion indicating that a supplementary dynamic downlink resource assignment may be provided via PDCCH after the SPS occasion. FIG. 7 shows an exemplary MAC CE 700 according to various exemplary embodiments. The base station 300 may send the exemplary MAC CE 700 to the UE 110 in a MAC protocol data unit (PDU) on the SPS PDSCH prior to or during a SPS occasion. The information field of the MAC CE 700 may contain information such as, but not limited to, when the UE 110 should use the active mode of monitoring PDCCH after the SPS occasion (e.g., offset value), how long the UE 110 should use the active mode of data monitoring PDCCH after the SPS occasion, whether the UE 110 should start, restart or extend a particular timer configured to control the UE 110 to utilize an active mode of monitoring PDCCH after the SPS occasion (with or without an offset), a timer value (e.g., how long the timer should be running after its triggered), whether the UE 110 should stop the timer if a PDCCH is received while the timer is running, the number of PDCCHs that the UE 110 should receive before stopping the timer, whether the UE 110 should stay active util the end of the next onDuration of the cDRX cycle and whether the UE 110 should pause cDRX operation. The “A” field may be configured to indicate if the UE 110 should use an active mode of monitoring PDCCH after the SPS occasion. For example, when a bit in this field is set to a first value (e.g., 0), this may indicate that the UE 110 is not to utilize the active mode of monitoring PDCCH. When a bit in this field is set to a second value (e.g., 1), this may indicate that the UE 110 is to utilize the active mode of monitoring PDCCH for supplementary dynamic downlink resource assignment. The “R” field represents multiple reserved bits. The exemplary MAC CE structure shown in FIG. 7 is merely provided for illustrative purposes. The exemplary embodiments may utilize any appropriate MAC CE structure to implement this exemplary MAC CE.

The base station 300 may provide the MAC CE 700 to the UE 110 prior to or during an SPS occasion when the base station 300 misses the SPS occasion due to late packet arrival or when the base station 300 uses additional resources to accommodate the size of the packet. Thus, another exemplary condition may include whether this type of MAC CE has been received prior to during the SPS occasion.

The exemplary MAC CE 700 may explicitly or implicitly instruct the UE 110 to utilize an active mode of monitoring PDCCH outside of an onDuration. For example, the MAC CE 700 may instruct the UE 110 to start, restart or extend a timer that is used to control when the UE 110 is to utilize the active of mode of data exchange processing for downlink reception. Additional details regarding utilizing timers to control when the UE 110 is in the active mode of monitoring PDCCH is provided below.

According to some aspects, the exemplary embodiments introduce L1 and L2 signaling that may be provided by the network prior to or during an SPS occasion indicating that a supplementary dynamic downlink resource assignment may be provided via PDCCH after the SPS occasion. In one example, a L1 signal may be provided prior to or during an SPS occasion configured to indicate whether the SPS PDSCH is empty. For example, the base station 300 may use this L1 signal to indicate that the SPS PDSCH is empty when late packet arrival due to jitter occurs and the base station 300 misses the SPS occasion. Thus, another exemplary condition may include whether this type of L1 signal has been received prior to during the SPS occasion.

In another example, a L1 and/or L2 signal may be provided by the network prior to during an SPS occasion configured to instruct the UE 110 to utilize an active mode of monitoring PDCCH after the SPS occasion. For example, the base station 300 may provide this L1/L2 signaling to the UE 110 prior to an SPS occasion when the base station 300 is likely to miss the SPS occasion due to late packet arrival or when the base station 300 uses additional time resources to accommodate the size of the packet. Thus, another exemplary condition may include whether this type of L1/L2 signaling has been received prior to during the SPS occasion.

Returning to 615, when a condition indicating that a supplementary dynamic downlink resource assignment is likely to be transmitted to the UE 110 has not occurred, the method 600 continues to 620. In 620, the UE 110 operates in accordance with the cDRX configuration. That is, since the UE 110 does not expect to receive a supplementary dynamic downlink resource assignment via PDCCH after the SPS occasion, the UE 110 may take advantage of the power saving benefits of the cDRX cycle without sacrificing XR performance.

When a condition indicating that a supplementary dynamic downlink resource assignment is likely to be transmitted to the UE 110 has occurred, the method 600 continues to 625. In 625, the UE 110 utilizes an active mode of monitoring PDCCH to receive PDCCH for supplementary dynamic downlink resource assignment regardless of the cDRX configuration.

Those skilled in the art will understand that the UE 110 may utilize the active mode of monitoring PDCCH in accordance with one or more timers operated by the UE 110. According to some aspects, the exemplary embodiments introduce a new timer that may be used to control whether the UE 110 is in the active mode of monitoring PDCCH reception when SPS operation has been impacted by certain characteristics of XR. Throughout this description, the exemplary timer may be referred to a “sps-drx-InactiviteTimer.” However, reference to the term sps-drx-InactiviteTimer is merely provided for illustrative purposes. Different entities may refer to similar mechanisms by a different name.

The sps-drx-InactiviteTimer may be started, restarted or extended in response to identifying the condition in 615 to ensure that the UE 110 is in the active mode of monitoring PDCCH to receive the PDCCH for the dynamic downlink resource assignment. For example, the UE 110 may initiate the sps-drx-InactiviteTimer during the SPS occasion or after the SPS occasion (with or without an offset relative to the SPS occasion). While the sps-drx-InactiviteTimer is running the UE 110 monitors PDCCH for the dynamic downlink resource assignment. Upon expiry of the sps-drx-InactiviteTimer, the UE 110 may enter a power saving mode and discontinue at least a subset of operations related to monitoring.

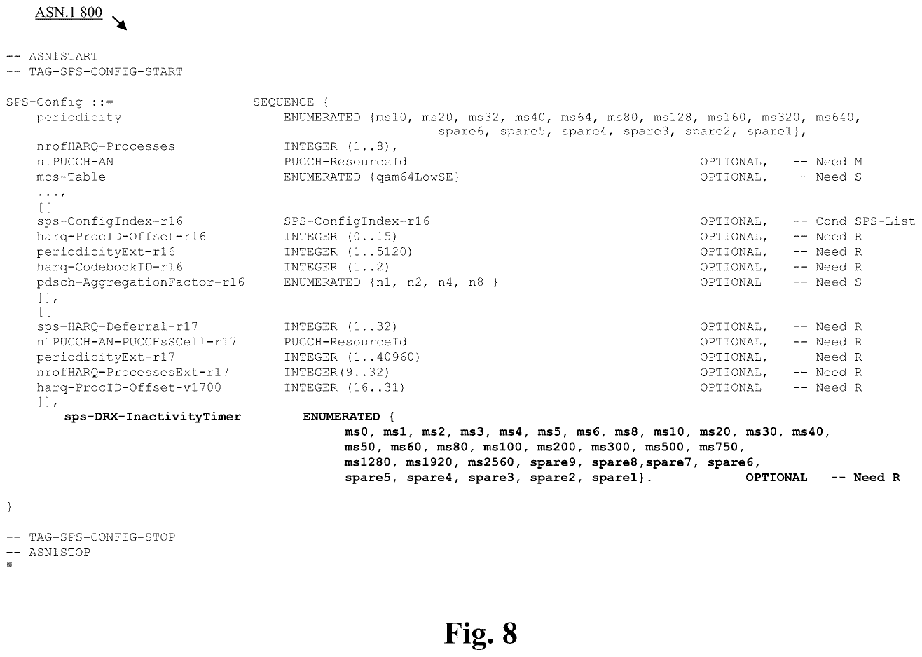

The network may configure the sps-drx-InactiviteTimer at the UE 110 using one or more RRC messages. For example, parameters for the sps-drx-InactiviteTimer may be provided as part of an SPS-config information element (IE) provided during 605. An example of the abstract syntax notation one (ANS.1) 800 for this exemplary type of RRC IE is provided in FIG. 8. In FIG. 8, an SPS-Config IE is shown to include a sps-drx-InactiviteTimer parameter that may be configured with any of a plurality of timer values measured in millisecond (ms) units.

According to another aspect, the exemplary embodiments may utilize currently defined timers such as, but not limited to, a drx-onDurationTimer, a dry-InactivyTimer or a drx-RetransmissionTimerDL, to ensure that the UE 110 is in the active mode of monitoring PDCCH to receive the PDCCH for the dynamic downlink resource assignment. These timers are defined in various 3GPP specifications and throughout this description, these timers may be used in the manner in which they are defined in the 3GPP Specifications and in accordance with the exemplary embodiments described herein.

In some embodiments, the timer drx-onDurationTimer may be started, restarted or extended in response to identifying the condition in 615 to ensure that the UE 110 is in the active mode of monitoring PDCCH to receive the PDCCH for the dynamic downlink resource assignment. When the drx-onDurationTimer is running the UE 110 may utilize the active mode of monitoring PDCCH. Upon expiry of the timer, the UE 110 may enter a power saving mode and conserve power by not monitoring PDCCH.

In other embodiments, the timer drx-InactivyTimer may be started, restarted or extended in response to identifying the condition in 615 to ensure that the UE 110 is in the active mode of monitoring PDCCH to receive the PDCCH for the dynamic downlink resource assignment. When the drx-InactivyTimer is running the UE 110 may utilize the active mode of monitoring PDCCH. Upon expiry of the timer, the UE 110 may enter a power saving mode and conserve power by not monitoring PDCCH.

In further embodiments, the timer drx-RetransmissionTimerDL may be started, restarted or extended in response to identifying the condition in 615 to ensure that the UE 110 is in the active mode of monitoring PDCCH to receive the PDCCH for the dynamic downlink resource assignment. When the drx-InactivyTimer is running the UE 110 may utilize the active mode of monitoring PDCCH. Upon expiry of the timer, the UE 110 may enter a power saving mode and conserve power by not monitoring PDCCH.

Instead of a timer-based approach, the UE 110 may decide to remain in the active mode of monitoring PDCCH until a next onDuration in response to identifying the condition in 615 to ensure that the UE 110 is in the active mode of monitoring PDCCH to receive the PDCCH for the dynamic downlink resource assignment.

In another approach, the UE 110 may pause cDRX operation in response to identifying the condition in 615 to ensure that the UE 110 is in the active mode of monitoring PDCCH to receive the PDCCH for the dynamic downlink resource assignment. In this example, the UE 110 may not resume operating in accordance with the cDRX configuration until an explicit or implicit instruction to do so is received from the network.

Returning to the method 600, in 630, the UE 110 returns to operating in accordance with the cDRX configuration. In some embodiments, if the UE 110 is expected to be in the sleep mode in accordance with the cDRX cycle but is instead using the active mode of monitoring PDCCH to receive the supplementary dynamic downlink resource assignment, the UE 110 may return to operating in accordance with the cDRX configuration as soon as one or more PDCCH for the dynamic downlink resource are received. That is, the UE 110 may immediately return to the sleep mode if the UE 110 has the opportunity to be in the sleep mode based on the cDRX cycle.

According to some aspects, the exemplary UE 110 behavior described above with regard to the method 600 may be dynamically activated and deactivated by the network. For example, the base station 300 may dynamically send a L1/L2 signal (e.g., DCI, MAC CE, etc.) to activate and deactivate the exemplary UE 110 behavior for one or more SPS configurations. In addition, the network may also indicate a time interval during which such UE 110 behavior is applicable. For example, the network may indicate that for the next N>1 SPS occasion, the UE 110 should utilize the configured exemplary UE 110 behavior describe above with regard to the method 600, e.g., use an active mode of monitoring PDCCH to receive supplementary dynamic downlink resource assignment via PDCCH regardless of the cDRX configuration.

In some embodiments, DCI configured for dynamically activating/deactivating this exemplary behavior may be based on DCI format 1_0, DCI format 1_1 or DCI format 1_2 addressed to the configured scheduling (CS)-radio network temporary identifier (RNTI) of the UE 110. The exemplary DCI may be configured with a new field that is configured to activate/deactivate the exemplary UE 110 behavior described herein.

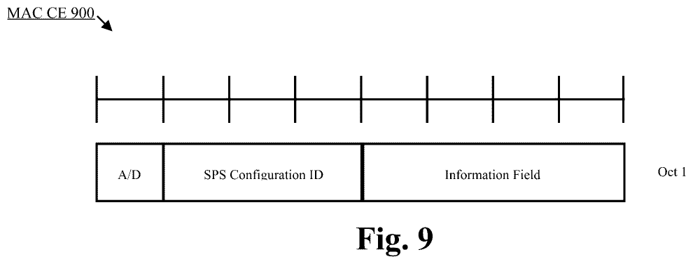

In some embodiments, a new MAC CE may be introduced for the activate/deactivation of this behavior. FIG. 9 shows an exemplary MAC CE 900 according to various exemplary embodiments. The information field may contain information such as, but not limited to, how long the UE 110 should use the exemplary UE 110 behavior for the targeted SPS configuration, a number of subsequent SPS occasions the UE 110 should apply the exemplary UE 110 behavior, a length or time the UE 110 should apply the exemplary UE 110 behavior or an indication that the UE 110 is to activate/deactivate the exemplary UE 110 behavior until a further instruction is received from the network. In some embodiments, the indication of how long the UE 110 should use the exemplary UE 110 behavior for the targeted SPS configuration may be managed by the UE 110 using a timer. For example, the timer may be initiated upon reception of the MAC CE 800 and the UE 110 activates/deactivates the exemplary UE 110 behavior until the timer expires.

The exemplary MAC CE 900 may also include an SPS configuration ID to indicate which SPS configuration that the MAC CE 900 is applicable. In addition, the exemplary MAC CE 900 may include an “A/D” field and when a bit in the A/D field is set to a first value (e.g., 0) this may indicate that the exemplary UE 110 behavior is to be activated. When the A/D filed is set to a second value (e.g., 1) this may indicate that the exemplary UE 110 behavior is to be deactivated. The exemplary MAC CE structure shown in FIG. 9 is merely provided for illustrative purposes. The exemplary embodiments may utilize any appropriate MAC CE structure to implement this exemplary MAC CE.

### EXAMPLES

In a first example, a method performed by a user equipment (UE), comprising receiving configuration information for a semi-persistent scheduling (SPS) configuration comprising one or more SPS occasions, determining whether a condition relating to the one or more SPS occasions of the SPS configuration has occurred and utilizing an active mode of monitoring physical downlink control channel (PDCCH) to receive a dynamic downlink resource assignment in response to determining that the condition relating to the one or more SPS occasions has occurred.

In a second example, the method of the first example, wherein the condition is whether the one or more SPS occasions are determined to be empty by the UE.

In a third example, the method of the second example, wherein the UE determined that the one or more SPS occasions are empty based on an absence of demodulated reference signal (DMRS).

In a fourth example, the method of the first example, wherein the condition is whether a medium access control (MAC) control element (CE) is received prior to or during an SPS occasion of the SPS configuration.

In a fifth example, the method of the fourth example, wherein the UE operates a timer that is configured to control a time interval where the UE is to use the active mode of monitoring PDCCH, and wherein the MAC CE comprises an information field containing at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.

In a sixth example, the method of the fourth example, wherein the MAC CE comprises an information field containing at least one or more of an indication as to whether the UE is to stay in the active mode of monitoring PDCCH until an end of a next onDuration and whether the UE is to pause connected discontinuous reception (cDRX) operation.

In a seventh example, the method of the first example, wherein the condition is whether a layer 1 (L1) signal is received prior to or during an SPS occasion of the SPS configuration.

In an eighth example, the method of the first example, wherein the condition is whether a layer 2 (L2) signal is received prior to or during an SPS occasion of the SPS occasion.

In a ninth example, the method of the first example, wherein the UE utilize the active mode of monitoring PDCCH after the SPS occasion and until a next onDuration, wherein the UE returns to operating in accordance with a connected discontinuous reception (cDRX) cycle upon the next onDuration.

In a tenth example, the method of the first example, wherein the UE pauses connected discontinuous reception (cDRX) operation based on identifying the condition relating to the one or more SPS occasions has occurred, where the cDRX operation is paused until a next instructs the UE to resume the cDRX operation.

In an eleventh example, the method of the first example, further comprising operating a timer that is configured to control a time interval where the UE is to utilize an active mode of monitoring PDCCH, wherein the timer is started, restarted or extended based on identifying the condition relating to the one or more SPS occasions has occurred.

In a twelfth example, the method of the eleventh example, wherein the timer is a dry-onDurationTimer, a drxInactiveTime or a drx-RetransmissionTimerDL.

In a thirteenth example, the method of the eleventh example, wherein configuration information for the timer is provided in the SPS configuration information.

In a fourteenth example, the method of the eleventh example, wherein the condition relating to the one or more SPS occasions has occurred is whether the UE received a medium access control (MAC) control element (CE) prior to or during the SPS occasion.

In a fifteenth example, the method of the fourteenth example, wherein the MAC CE comprises an information field containing information related to operating the timer.

In a sixteenth example, the method of the fifteenth example, wherein the information related to operating the timer includes at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.

In a seventeenth example, the method of the first example, further comprising receiving, prior to the SPS occasion, a medium access control (MAC) control element (CE), wherein the MAC CE activates a UE configuration for utilizing an active mode of monitoring PDCCH to receive PDCCH for the dynamic downlink resource assignment in response to determining whether the condition relating to one or more SPS occasions of the SPS configuration has occurred.

In an eighteenth example, a processor configured to perform any of the methods of the first through seventeenth examples.

In a nineteenth example, a user equipment (UE) comprising a transceiver configured to communicate with a network and a processor communicatively coupled to the transceiver and configured to perform any of the methods of the first through seventeenth examples.

In a twentieth example, a method performed by a base station, comprising transmitting configuration information for a semi-persistent scheduling (SPS) configuration to a user equipment (UE) and transmitting a dynamic downlink resource assignment to the UE after a condition relating to one or more SPS occasions of the SPS configuration has occurred, wherein the dynamic downlink resource assignment is transmitted on a physical downlink control channel (PDCCH).

In a twenty first example, the method of the twentieth example, further comprising transmitting a medium access control (MAC) control element (CE) to the UE prior to or during an SPS occasion of the SPS configuration, wherein the MAC CE indicates to the UE that the UE is to utilize an active mode of monitoring PDCCH to receive the dynamic downlink resource assignment outside of an onDuration of a connected discontinuous reception cycle (cDRX) cycle.

In a twenty second example, the method of the twenty first example, wherein the UE operates a timer that is configured to control a time interval wherein the UE is to use the active mode of monitoring PDCCH, and wherein the MAC CE comprises an information field containing at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.

In a twenty third example, the method of the twenty first example, wherein the MAC CE comprises an information field containing at least one or more of an indication as to whether the UE is to stay in the active mode of monitoring PDCCH until an end of a next onDuration and whether the UE is to pause connected discontinuous reception (cDRX) operation.

In a twenty fourth example, the method of the twentieth example, further comprising transmitting a layer 1 (L1) signal to the UE prior to or during an SPS occasion of the SPS configuration, wherein the L1 signal indicates to the UE that the UE is to utilize an active mode of monitoring PDCCH to receive the dynamic downlink resource assignment outside of an onDuration of a connected discontinuous reception (cDRX) cycle.

In a twenty sixth example, the method of the twentieth example, further comprising transmitting a layer 2 (L2) signal to the UE prior to or during the SPS occasion, wherein the L1 signal indicates to the UE that the UE is to utilize an active mode of monitoring PDCCH to receive the dynamic downlink resource assignment outside of an onDuration of a connected discontinuous reception (cDRX) cycle.

In a twenty seventh example, the method of the twentieth example, further comprising transmitting a signal to the UE prior to or during the SPS occasion, wherein the signal is one of a medium access control (MAC) control element (CE), a layer 1 (L1) signal or an layer 2 (L2) signal, wherein the UE operates a timer to control a time interval where the UE is to utilize an active mode of monitoring PDCCH, wherein the timer is started, restarted or extended based on the signal.

In a twenty eighth example, the method of the twenty seventh example, wherein the timer is a drx-onDurationTimer, a drxInactiveTime or a drx-RetransmissionTimerDL.

In a twenty ninth example, the method of the twenty seventh example, wherein configuration information for the timer is included in the SPS configuration information.

In a thirtieth example, the method of the twenty seventh example, wherein the signal comprises an information field containing information related to operating the timer.

In a thirty first example, the method of the twenty seventh example, wherein the information related to operating the timer includes at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.

In a thirty second example, the method of the twentieth example, further comprising transmitting, prior to an SPS occasion of the SPS configuration, a medium access control (MAC) control element (CE) to the UE, wherein the MAC CE activates a UE configuration for utilizing an active mode of monitoring PDCCH to receive PDCCH for the dynamic downlink resource assignment outside of the onDuration of the cDRX cycle.

In a thirty third example, a processor configured to perform any of the methods of the twentieth through thirty second examples.

In a thirty fourth example, a base station comprising a transceiver configured to communicate with a user equipment (UE) and a processor communicatively coupled to the transceiver and configured to perform any of the methods of the twentieth through thirty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, from signaling received from a base station, configuration information for a semi-persistent scheduling (SPS) configuration comprising one or more SPS occasions;
determine whether a condition relating to the one or more SPS occasions of the SPS configuration has occurred; and
utilize an active mode of monitoring a physical downlink control channel (PDCCH) to receive a dynamic downlink resource assignment in response to determining that the condition relating to the one or more SPS occasions has occurred.

2. The apparatus of claim 1, wherein the condition is whether the one or more SPS occasions are determined to be empty by the UE.

3. The apparatus of claim 1, wherein the condition is whether a medium access control (MAC) control element (CE) is received prior to or during an SPS occasion of the SPS configuration.

4. The apparatus of claim 3, wherein the apparatus operates a timer that is configured to control a time interval where the UE is to use the active mode of monitoring PDCCH, and
wherein the MAC CE comprises an information field containing at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.

5. The apparatus of claim 3, wherein the MAC CE comprises an information field containing at least one or more of an indication as to whether the UE is to stay in the active mode of monitoring PDCCH until an end of a next onDuration and whether the UE is to pause connected discontinuous reception (cDRX) operation.

6. The apparatus of claim 1, wherein the processing circuitry is further configured to:
operate a timer that is configured to control a time interval where the UE is to utilize an active mode of monitoring PDCCH, wherein the timer is started, restarted or extended based on identifying the condition relating to the one or more SPS occasions has occurred.

7. The apparatus of claim 6, wherein configuration information for the timer is provided in the SPS configuration information.

8. The apparatus of claim 6, wherein the condition relating to the one or more SPS occasions has occurred is whether the UE received a medium access control (MAC) control element (CE) prior to or during the one or more SPS occasions, wherein the MAC CE comprises an information field containing information related to operating the timer comprising at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.

9. The apparatus of claim 1, wherein the processing circuitry is further configured to:
decode, from signaling received from the base station prior to the one or more SPS occasions, a medium access control (MAC) control element (CE), wherein the MAC CE activates a UE configuration for utilizing an active mode of monitoring PDCCH to receive PDCCH for the dynamic downlink resource assignment in response to determining whether the condition relating to one or more SPS occasions of the SPS configuration has occurred.

10. An apparatus of a base station, the apparatus comprising processing circuitry configured to:
configure transceiver circuitry to transmit configuration information for a semi-persistent scheduling (SPS) configuration to a user equipment (UE); and
configure transceiver circuitry to transmit a dynamic downlink resource assignment to the UE after a condition relating to one or more SPS occasions of the SPS configuration has occurred, wherein the dynamic downlink resource assignment is transmitted on a physical downlink control channel (PDCCH).

11. The apparatus of claim 10, wherein the processing circuitry is further configured to:
configure transceiver circuitry to transmit a medium access control (MAC) control element (CE) to the UE prior to or during an SPS occasion of the SPS configuration, wherein the MAC CE indicates to the UE that the UE is to utilize an active mode of monitoring PDCCH to receive the dynamic downlink resource assignment outside of an onDuration of a connected discontinuous reception cycle (cDRX) cycle.

12. The apparatus of claim 11, wherein the UE operates a timer that is configured to control a time interval, wherein the UE is to use the active mode of monitoring PDCCH, and wherein the MAC CE comprises an information field containing at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.

13. The apparatus of claim 11, wherein the MAC CE comprises an information field containing at least one or more of an indication as to whether the UE is to stay in the active mode of monitoring PDCCH until an end of a next onDuration and whether the UE is to pause connected discontinuous reception (cDRX) operation.

14. The apparatus of claim 10, wherein the processing circuitry is further configured to:
configure transceiver circuitry to transmit a layer 1 (L1) signal to the UE prior to or during an SPS occasion of the SPS configuration, wherein the L1 signal indicates to the UE that the UE is to utilize an active mode of monitoring PDCCH to receive the dynamic downlink resource assignment outside of an onDuration of a connected discontinuous reception (cDRX) cycle.

15. The apparatus of claim 10, wherein the processing circuitry is further configured to:
configure transceiver circuitry to transmit a layer 2 (L2) signal to the UE prior to or during the one or more SPS occasions, wherein the L2 signal indicates to the UE that the UE is to utilize an active mode of monitoring PDCCH to receive the dynamic downlink resource assignment outside of an onDuration of a connected discontinuous reception (cDRX) cycle.

16. The apparatus of claim 10, wherein the processing circuitry is further configured to:
configure transceiver circuitry to transmit a signal to the UE prior to or during the one or more SPS occasions, wherein the signal is one of a medium access control (MAC) control element (CE), a layer 1 (L1) signal or a layer 2 (L2) signal,
wherein the UE operates a timer to control a time interval where the UE is to utilize an active mode of monitoring PDCCH,
wherein the timer is started, restarted or extended based on the signal.

17. The apparatus of claim 16, wherein the timer is a dry-onDurationTimer, a drxInactiveTime or a drx-RetransmissionTimerDL.

18. The apparatus of claim 17, wherein configuration information for the timer is included in the SPS configuration information.

19. The apparatus of claim 17, wherein the signal comprises an information field containing information related to operating the timer.

20. The apparatus of claim 19, wherein the information related to operating the timer includes at least one or more of a timer value, an indication of whether the UE is to stop the timer after the dynamic downlink resource assignment is received, a number of PDCCH that the UE is to receive before stopping the timer and indications as to whether the UE is to start, restart or extend the timer.
